(19) United States
(12) Patent Application Publication
(10) Pub. No.: US 2020/0128143 A1
(43) Pub. Date: Apr. 23, 2020

(54) IMAGE PROCESSING APPARATUS, OPERATION CONTROL METHOD FOR SAME AND NON-TRANSITORY COMPUTER-READABLE RECORDING MEDIUM

(71) Applicant: KONICA MINOLTA, INC., Tokyo (JP)

(72) Inventor: Daiki NISHIOKA, Tokyo (JP)

(73) Assignee: KONICA MINOLTA, INC., Tokyo (JP)

(21) Appl. No.: 16/599,649

(22) Filed: Oct. 11, 2019

(30) Foreign Application Priority Data
Oct. 17, 2018 (JP) 2018-195644

(51) Int. Cl. H04N 1/00; G10L 15/22; G10L 15/25

(52) U.S. Cl. CPC H04N 1/00403; H04N 1/00251; G10L 15/22; G10L 15/25; G10L 2015/223; H04N 1/00488; H04N 1/00244; H04N 2201/0094; H04N 1/00408

(57) ABSTRACT

Provided are an image processing apparatus, an operation control method and a non-transitory computer-readable recording medium. The image processing apparatus uses information of operator's voice sounds and video information given by shooting the operator, to perform the following operations. For example, in response to recognizing an operation command in the sound information during detection of operator's lip movements in the video information, the apparatus executes the operation command. For another example, in response to recognizing an operation command in the sound information, the apparatus judges whether an operator is detected in the video information. When no operator is detected, the apparatus controls one or more operations in which the apparatus makes operation noise being greater than a predetermined level of loudness, or causes an user interface or a speaker of the apparatus to output information to prompt the operator to input instructions by hand.

Japanese Patent Application No. 2018-195644 filed on Oct. 17, 2018, including description, claims, drawings, and abstract, the entire disclosure of which is incorporated herein by reference in its entirety.

### TECHNOLOGICAL FIELD

The present invention is directed to image processing apparatuses, methods for controlling, operations of an image processing apparatus, and non-transitory computer-readable recording media each storing a program for controlling operations of an image processing apparatus. In particular, the present invention is directed to image processing apparatuses that provide voice command capabilities, and operation control methods and non-transitory computer-readable recording media each storing an operation control program, that allow an operator to operate the image processing apparatus with voice commands.

### BACKGROUND

AI (artificial intelligence) technology for speech recognition has rapidly advanced in these years, and various manufacturers that produce speech recognition products are planning to incorporate AI-assisted speech recognition into their office-use products. Also manufacturers that produce image forming apparatuses like MFPs (multi-functional peripherals) have already made a start on implementation of various functions using AI-assisted speech recognition into their products, and have actually produced products with voice command capabilities and products with consumable ordering capabilities. In office environments, operations of such MFPs using AI-assisted speech recognition have problems that surrounding noise can affect speech recognition of the MFPs and cause erroneous speech recognition.

As an example of techniques to control the influence of noise on speech recognition, Japanese Unexamined Patent Publication (JP-A) No. 2010-068026 discloses the following image forming apparatus. The image forming apparatus is configured to accept operator's instructions in a voice-operation mode in which the apparatus accepts voice commands given by an operator or in a non-voice-operation mode in which the apparatus does not accept voice commands. The image forming apparatus includes a storage device and records input jobs into the storage device. The image forming apparatus estimates the level of loudness of operating noise that the apparatus makes during processing of each job recorded in the storage device. When jobs recorded in the storage device are to be processed in the voice-operation mode, the image forming apparatus processes the jobs in order of smallest operating noise to largest operating noise.

The image forming apparatus disclosed in JP-A No. 2010-068026 is configured to, during voice input by an operator, process a job that makes the smallest operating noise first, so as to reduce the influence of operation noises on recognition of operator's speech. However, not only noises made by a MFP, but also surrounding noise considerably affects the voice input. In the technique disclosed in JP-A No. 2010-068026, the image forming apparatus is designed without consideration for the influence of surrounding noise, and may still carry out erroneous speech recognition originated by surrounding noise. This problem cart arise in various kinds of image processing apparatus, not only in MFPs, but also in scanners and facsimile machines, in a same manner.

### SUMMARY

The present invention is directed to image processing apparatuses, methods for controlling operations of an image processing apparatus, and non-transitory computer-readable recording media each storing a program for controlling operations of an image processing apparatus, that eliminate erroneous speech recognition and allow the image processing apparatuses to execute commands or instructions given by an operator accurately.

An image processing apparatus reflecting one aspect of the present invention comprises an user interface comprising a display that presents information to an operator and an input hardware device that receives an instruction given by the operator. The image processing apparatus further comprises a sound receiver that obtains operator's voice sounds and outputs sound information; an image capturer that shoots the operator and outputs video information; and a hardware processor. The hardware processor is communicably connected to the user interface, the sound receiver and the image capturer, and performs the following operations. The operations comprise: first analyzing the sound information to recognize an operation command to operate the image processing apparatus in the sound information; and second analyzing the video information to detect movements of operator's lips in the video information. The operations further comprise, in response to recognizing an operation command to operate the image processing apparatus in the first analyzing during detection of the movements of operator's lips in the second analyzing, executing the operation command.

An image processing apparatus reflecting one aspect of the present invention comprises: an user interface comprising a display that presents information to an operator and an input hardware device that receives an instruction given by the operator. The image processing apparatus further comprises a sound receiver that obtains operator's voice sounds and outputs sound information; an image capturer that shoots the operator and outputs video information; a speaker that outputs sound information to the operator; and a hardware processor. The hardware processor is communicably connected to the user interface, the sound receiver, the image capturer and the speaker, and performs the following operations. The operations comprise: first analyzing the sound information to recognize an operation command to operate the image processing apparatus in the sound information; second analyzing the video information to detect the operator in the video information; and in response to recognizing an operation command to operate the image processing apparatus in the first analyzing, judging whether the operator is detected in the video information. The operations further comprise, on judging that no operator is detected in the video information, carrying out either of: checking operations currently performed by the image processing apparatus and controlling one or more operations, in which the image processing apparatus makes operation noise being greater than a predetermined level of loudness, among the operations checked, so as to reduce the operation noise; or causing the display of the user interface or the speaker to output information to prompt the operator to input, through the input hardware device of the user interface by hand an instruction to operate the image processing apparatus.

An operation control method reflecting one aspect of the present invention is a method for controlling operations of an image processing apparatus. The image processing apparatus is equipped with: an user interface that presents information to an operator with a display and receives an instruction given by the operator with an input hardware device; a sound receiver that obtains operator's voice sounds and outputs sound information; and an image capturer that shoots the operator and outputs video information. The method comprises first analyzing, by one or more hardware processors that control the image processing apparatus, the sound information to recognize an operation command to operate the image processing apparatus in the sound information. The method further comprises second analyzing, by one or more hardware processors that control the image processing apparatus, the video information to detect movements of operator's lips in the video information. The method further comprises, in response to recognizing an operation command to operate the image processing apparatus in the first analyzing during detection of the movements of operator's lips in the second analyzing, executing, by one or more hardware processors that control the image processing apparatus, the operation command.

An operation control method reflecting one aspect of the present invention is a method for controlling operations of an image processing apparatus. The image processing apparatus is equipped with: an user interface that presents information to an operator with a display and receives an instruction given by the operator with an input hardware device; a sound receiver that obtains operator's voice sounds and outputs sound information; and an image capturer that shoots the operator and outputs video information. The method comprises first analyzing, by one or more hardware processors that control the image processing apparatus, the sound information to recognize an operation command to operate the image processing apparatus in the sound information. The method further comprises second analyzing, by one or more hardware processors that control the image processing apparatus, the video information to detect the operator in the video information. The method further comprises, in response to recognizing an operation command to operate the image processing apparatus in the first analyzing, judging, by one or more hardware processors that control the image processing apparatus, whether the operator is detected in the video information. The method further comprises, on judging that no operator is detected in the video information, carrying out, by one or more hardware processors that control the image processing apparatus, either of: checking operations currently performed by the image processing apparatus and controlling one or more operations, in which the image processing apparatus makes operation noise being greater than a predetermined level of loudness, among the operations checked, so as to reduce the operation noise; or causing the display of the user interface or a speaker of the image processing apparatus to output information to prompt the operator to input, through the input hardware device of the user interface by hand, an instruction to operate the image processing apparatus.

A non-transitory computer-readable recording medium reflecting one aspect of the present invention stores a program for controlling operations of an image processing apparatus. The image processing apparatus is equipped with: an user interface that presents information to an operator with a display and receives an instruction given by the operator with an input hardware device; a sound receiver that obtains operator's voice sounds and outputs sound information; and an image capturer that shoots the operator and outputs video information. The program comprises instructions which, when being executed by a hardware processor of the image processing apparatus, cause the hardware processor to perform the following operations. The operations comprise first analyzing the sound information to recognize an operation command to operate the image processing apparatus in the sound information. The operations further comprise second analyzing the video information to detect movements of operator's lips in the video information. The operations further comprise, in response to recognizing an operation command to operate the image processing apparatus in the first analyzing during detection of the movements of operator's lips in the second analyzing, executing the operation command.

A non-transitory computer-readable recording medium reflecting one aspect of the present invention stores a program for controlling operations of an image processing apparatus. The image processing apparatus is equipped with: an user interface that presents information to an operator with a display and receives an instruction given by the operator with an input hardware device; a sound receiver that obtains operator's voice sounds and outputs sound information; and an image capturer that shoots the operator and outputs video information. The program comprises instructions which, when being executed by a hardware processor of the image processing apparatus, cause the hardware processor to perform the following operations. The operations comprise first analyzing the sound information to recognize an operation command to operate the image processing apparatus in the sound information. The operations further comprise second analyzing the video information to detect the operator in the video information. The operations further comprise, in response to recognizing an operation command to operate the image processing apparatus in the first analyzing, judging whether the operator is detected in the video information. The operations further comprise, on judging that no operator is detected in the video information, carrying out either of: checking operations currently performed by the image processing apparatus and controlling one or more operations, in which the image processing apparatus makes operation noise being greater than a predetermined level of loudness, among the operations checked, so as to reduce the operation noise; or causing the display of the user interface or a speaker of the image processing apparatus to output information to prompt the operator to input, through the input hardware device of the user interface by hand, an instruction to operate the image processing apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram illustrating an example of the constitution of an operation control system according to the first embodiment;

FIG. 2 is a schematic diagram illustrating another example of the constitution of an operation control system according to the first embodiment;

FIGS. 3A and 3B are block diagrams illustrating an example of the constitution of an image forming apparatus according to the first embodiment;

FIG. 4 is a flowchart illustrating an example of operations (basic operations) of the image forming apparatus according to the first embodiment;

FIG. 5 is a flowchart illustrating another example of operations (operations using lip-reading) of the image forming apparatus according to the first embodiment;

FIG. 6 is a flowchart illustrating another example of operations (operations with difficulty in speech recognition) of the image forming apparatus according to the first embodiment;

FIG. 7 is a flowchart illustrating another example of operations (operations with difficulty in speech recognition) of the image forming apparatus according to the first embodiment;

FIG. 8 is a flowchart illustrating another example of operations (operations when confidential information is input) of the image forming apparatus according to the first embodiment;

FIG. 9 is a flowchart illustrating another example of operations (operations when confidential information is input) of the image forming apparatus according to the first embodiment;

FIG. 10 is a flowchart illustrating another example of operations (operations when confidential information is input) of the image forming apparatus according to the first embodiment;

FIG. 11 is a diagram illustrating an example of a notification screen to be displayed on the image forming apparatus according to the first embodiment;

FIG. 12 is a diagram illustrating another example of a notification screen to be displayed on the image forming apparatus according to the first embodiment;

FIG. 13 is a diagram illustrating another example of a notification screen to be displayed on the image forming apparatus according to the first embodiment;

FIG. 14 is a flowchart illustrating an example of operations (operations with difficulty in speech recognition) of the image forming apparatus according to the second embodiment; and

FIG. 15 is a flowchart illustrating another example of operations (operations with difficulty in speech recognition) of the image forming apparatus according to the second embodiment.

### DETAILED DESCRIPTION OF EMBODIMENTS

Hereinafter, one or more embodiments of the present invention will be described with reference to the drawings. However, the scope of the invention is not limited to the illustrated embodiments.

As indicated in BACKGROUND, manufacturers that produce image forming apparatuses like MFPs have already made a start on implementation of various functions using AI-assisted speech recognition into their products, and have actually produced products with voice command capabilities and products with consumable ordering capabilities. In office environments, operations of such MFPs using AI-assisted speech recognition have problems that surrounding noise can affect speech recognition of the MFPs and cause erroneous speech recognition.

To solve the problem, the image forming apparatus disclosed in JP-A No. 2010-068026 is configured to process, during voice input by an operator, a job that makes the smallest operating noise first, so as to reduce the influence of operation noises on recognition of operator's speech. However, not only noises made by a MFP, but also surrounding noise considerably affects the voice input. Since the disclosed image forming apparatus is designed without consideration for the influence of surrounding noise, the apparatus may still carry out erroneous speech recognition originated by surrounding noise. This problem can arise in various kinds of image processing apparatus, not only in MFPs, but also in scanners and facsimile machines, in a same manner.

In view of that, the following image processing apparatus is provided as one embodiment of the present embodiment. The image processing apparatus is configured to obtain information given by shooting an operator (video information) together with information of operator's voice sounds (sound information), and work by using the video information and the sound information so as to eliminate erroneous speech recognition and execute commands or instructions given by an operator accurately.

For example, there is provided an image processing apparatus equipped with an image processor that creates or processes image data. The image processing apparatus includes an user interface that includes a display that presents information to an operator and an input hardware device that receives an instruction given by the operator by hand. The image processing apparatus further includes a sound receiver that obtains operator's voice sounds and outputs sound information, and an image capturer that shoots the operator and outputs video information. One or more hardware processors, such as a hardware processor of the image processing apparatus and/or a hardware processor of an apparatus connected to the image processing apparatus, perform the following operations. That is, one or more hardware processors analyze the sound information to recognize an operation command to operate the image processing apparatus in the sound information, and also analyze the video information to detect movements of operator's lips in the video information. In response to recognition of an operation command to operate the image processing apparatus in the sound-information analysis during detection of the movements of operator's lips in the video-information analysis, one or more hardware processors execute the operation command so as to control operations of the image processing apparatus according to the operation command. In concrete terms, one or more hardware processors may determine an operator's utterance by interpreting the movements of operator's lips, and judge whether the utterance matches the operation command recognized in the sound-information analyzing. When judging that the utterance matches the operation command, the one or more hardware processors may execute the operation command. On the other hand, when judging that the utterance does not match the operation command, the one or more hardware processors may cause the display of the user interface to display information to prompt the operator to input an instruction by voice sound again.

For another example, there is provided an image processing apparatus equipped with an image processor that creates or processes image data. The image processing apparatus includes an user interface that includes a display that presents information to an operator and an input hardware device that receives an instruction given by the operator by hand. The image processing apparatus further includes a sound receiver that obtains operator's voice sounds and outputs sound information, and an image capturer that shoots the operator and outputs video information. One or more hardware processors, such as a hardware processor of the image processing apparatus and/or a hardware processor of an apparatus connected to the image processing apparatus, perform the following operations. That is, one or more hardware processors analyze the sound information to recognize an operation command to operate the image processing apparatus in the sound information, and also analyze the video information to detect the operator in the video information. In response to recognition of an operation command to operate the image processing apparatus in the sound-information analysis, one or more hardware processors judge whether the operator is detected in the video information. When judging that no operator is detected in the video information, one or more hardware processors check operations currently performed by the image processing apparatus and control one or more operations, in which the image processing apparatus makes operation noise being greater than a predetermined level of loudness, among the operations checked, so as to reduce the operation noise. Alternatively, when judging that no operator is detected in the video information, one or more hardware processors cause the display of the user interface or a speaker of the image forming apparatus to output information to prompt the operator to input, through the input hardware device of the user interface by hand, an instruction to operate the image processing apparatus.

As described above, the image processing apparatuses analyze video information to detect an operator or movements of operator's lips, and, as needed, carry out lip-reading which determines what the operator is saying (operator's utterance) by interpreting the movements of operator's lips. It eliminates erroneous speech recognition originated by surrounding noise during voice input, and allows the image processing apparatuses to execute commands or instructions given by an operator accurately.

### First Embodiment

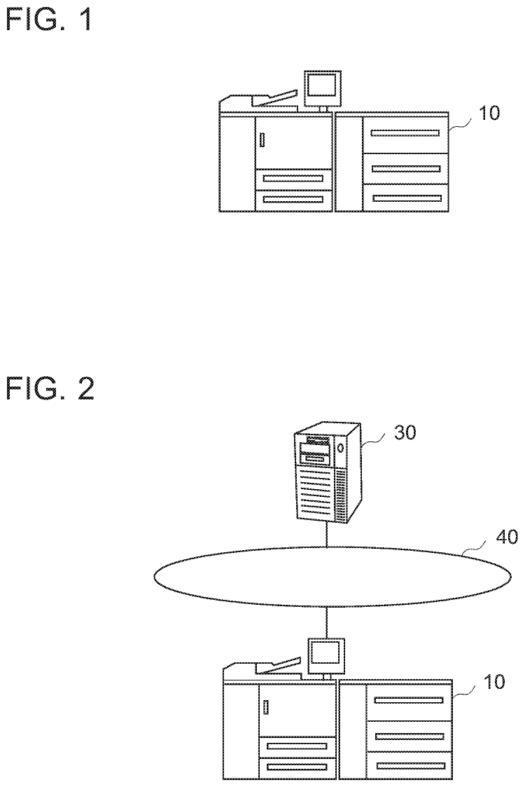

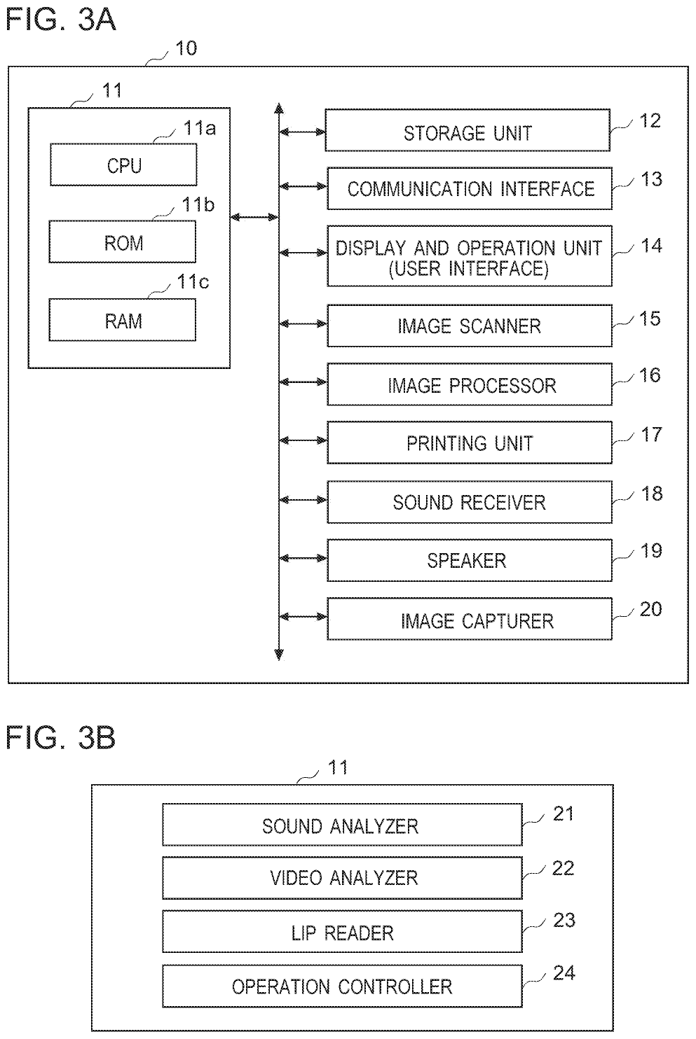

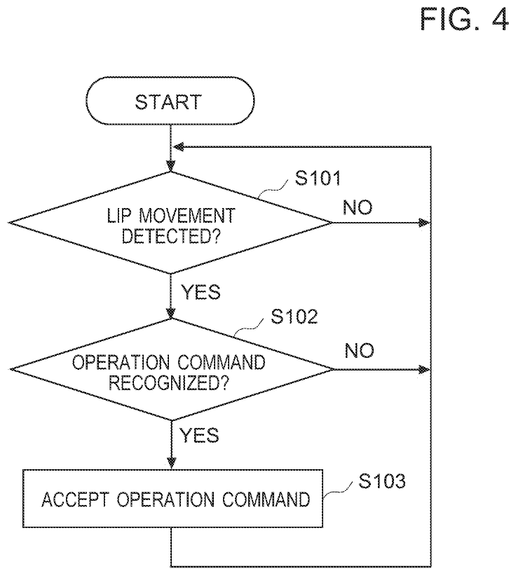

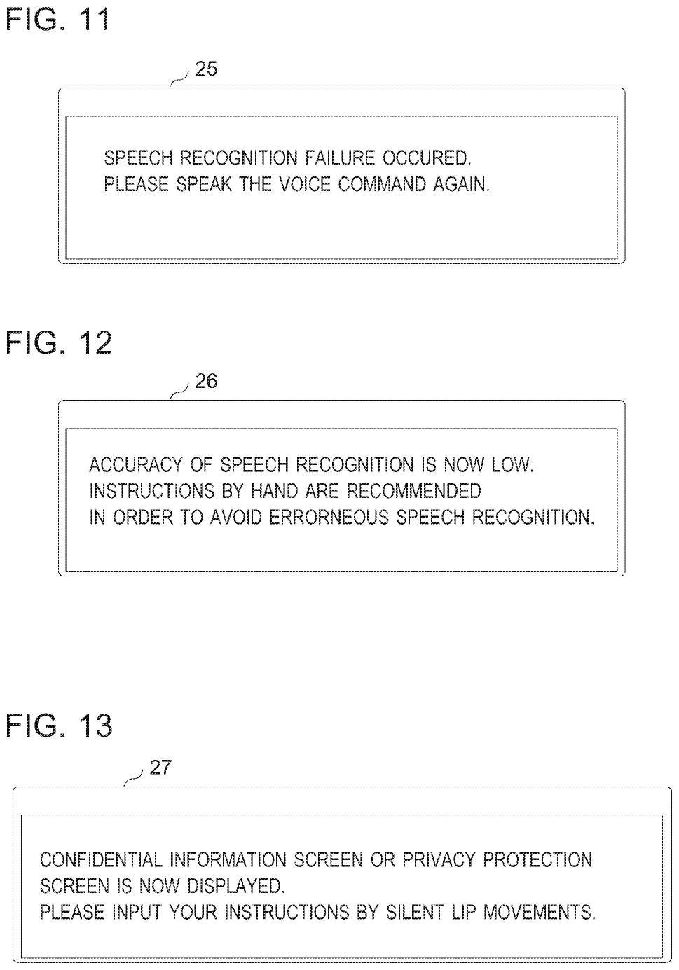

In order to describe an embodiment of the present invention in more in detail, a description is given of an image processing apparatus, a method for controlling operations of the image processing apparatus, and a non-transitory computer-readable recording medium storing a program for controlling operations of the image processing apparatus, with reference to FIG. 1 through FIG. 13. FIG. 1 and FIG. 2 each is a schematic diagram illustrating an example of the constitution of an operation control system according to the present embodiment. FIGS. 3A and 3B are block diagrams illustrating an example of the constitution of an image forming apparatus according to the present embodiment, which is an instance of the image processing apparatus. FIGS. 4 to 10 each is a flowchart illustrating an example of operations of the image forming apparatus. FIGS. 11 to 13 each is a diagram illustrating an example of a notification screen to be displayed on the image forming apparatus.

An operation control system according to the present embodiment includes an image processing apparatus that is equipped with an image processor that creates or processes image data and that provides one or more selected from scanning functions using an image scanner, facsimile functions using a communication interface, and printing functions using a print engine. In the present embodiment, image forming apparatus 10 including a print engine, is employed as an instance of the image processing apparatus, as illustrated in FIG. 1. The image forming apparatus 10 is configured to carry out sound-information analysis (by a sound analyzer), video-information analysis (by a video analyzer) and lip-reading (by a lip reader), which will be described in detail below, but these functions may be given by one or more external apparatuses communicably connected to image forming apparatus 10. In this case, as illustrated in FIG. 2, the operation control system may include image forming apparatus 10 and analysis server 30, which are communicably connected to each other via communication network 40, so that one or more selected from the sound-information analysis, the video-information analysis and the lip-reading can be carried out by a hardware processor of analysis server 30 instead of that of image forming apparatus 10. Examples of the communication network 40 include a LAN (Local Area Network) and WAN (Wide Area Network) according to the standards such as Ethernet, Token Ring and FDDI (Fiber-Distributed Data Interface). Hereinafter, a description of each apparatus in the system is given on the assumption of the constitution of the system illustrated in FIG. 1.

### Image Forming Apparatus

Image forming apparatus 10 includes, as illustrated in FIG. 3A, built-in controller 11, storage unit 12, communication interface 13, display and operation unit 14, image scanner 15, image processor 16, printing unit 17, sound receiver 18, speaker 19 and image capturer 20.

Built-in controller 11 includes CPU (Central Processing Unit) 11a, which is a hardware processor communicably connected to components of image forming apparatus 10 so as to control the components. Built-in controller 11 further includes memories including ROM (Read Only Memory) 11b and RAM (Random Access Memory) 11c. CPU 11a reads out control programs stored in ROM 11b or storage unit 12, loads the control programs onto RAM 11c, and executes the control programs, thereby controlling operations of image forming apparatus 10.

Storage unit 12 is a non-transitory computer-readable recording medium including a HDD (Hard Disk Drive) and/or a SSD (Solid State Drive), which stores programs which, when being executed, causes CPU 11a to control operations of the components of image forming apparatus 10, information about processing and functions of image forming apparatus 10, information about the status of each component of image forming apparatus 10 and other data.

Communication interface 13 includes a NIC (Network Interface Card) and/or a modem, and communicably connects image forming apparatus 10 to communication network 40 so as to electronically send information to or receive information from one or more external apparatuses connected to communication network 40. For example, communication interface 13 may be configured to receive a job from a client terminal, send sound information and video information to analysis server 30, and/or receive analysis results of sound information and video information (such as an operation command recognized in sound information, movements of operator's lips detected from video information, and information like words spoken by an operator determined by lip-reading) from analysis server 30. As needed, communication interface 13 may serve as a facsimile terminal that carries out facsimile communications according to the procedures for facsimile communication, described by five phases of Phases A to E, specified by ITU-T recommendation T.30 regulated by Telecommunication Standardization Sector of International Telecommunications Union. In other words, communication interface 13 may be configured to send document images (documents in a graphic image form) to anther facsimile machine and/or receive document images from anther facsimile machine, along transmission lines like PSTN (public switched telephone networks).

Display and operation unit 14 is an user interface including an input hardware device that receives various commands or instructions to operate image forming apparatus 10, given by an operator by hand, and an output hardware device that presents information to an operator. In concrete terms, display and operation unit 14 is configured to display, with the output display device like a display, various screens relating to operations of image forming apparatus 10, and to receive, with the input display device, various kinds of operator's input for operating image forming apparatus 10 on the screens. Examples of the screens of this embodiment include notification screens and screens for inputting confidential information, which will be described later. Examples of the display and operation unit 14 include a touch screen in which an input hardware device like a touch sensor composed of lattice-shaped transparent electrodes is arranged on a display (an output hardware device) like a LCD (liquid crystal display) or an OEL (organic electroluminescence) display. Display and operation unit 14 may further include another kind of input hardware device like hardware keys (hardware buttons). Alternatively, display and operation unit 14 may include the output hardware device and the input hardware device as separated bodies, instead of a touch screen.

Image scanner 15 includes an automatic document feeder or ADF, and a component for scanning a document (image scanner component). The automatic document feeder includes a sheet conveyer so as to pick up an original in an original paper tray one page at a time and feed the original to the image scanner component. The image scanner component includes a CCD (charge-coupled device) array that optically scans an original. The CCD array optically scans an original placed on a glass platen, which was conveyed from the ADF onto the glass platen or given by an operator onto the glass platen, and obtains an image of the original, by shining white light onto the original to be scanned and collecting light reflected from the original onto a light receiving face of the CCD array. Image scanner 15 is configured to scan an original with the image scanner component and output the obtained original image as analog image signal to image processor 16 so as to be subjected to image processing.

Image processor 16 includes analog-to-digital (A/D) converter circuit and digital-image processor circuit, so as to create or process image data. Image processor 16 is configured to create digital image data, by carrying out A/D conversion onto analog image signal given from image scanner 15, or by analyzing a print job given front an external information processing device (like a client terminal) and rasterizing pages of a document given by the print job. Image processor 16 is further configured to carry out image processing, such as color conversion, correction according to initial settings or user settings (like shading correction) and image compression, onto the image data as needed, and output the resulting image data to printing unit 17.

Printing unit 17 is a print engine configured to use image data given from image processor 16 to form images on media sheets (print processing). Printing unit 17 includes components necessary: for forming images on media sheets by using electrographic process or electrostatic recording process. In concrete terms, printing unit 17 includes a charging unit, a photoreceptor drum, an exposure unit, a developing unit, transfer rollers, a transfer belt and a fixing unit, and is configured to perform print processing as follows. The charging unit charges the photoreceptor drum, and the exposure unit irradiates the photoreceptor drum with a light beam in accordance with image data, to create a latent image. The developing unit adheres charged toner onto the photoreceptor drum, to develop the image. The developed toner image is transferred onto the transfer belt from the photoreceptor drum by the transfer rollers (the first transfer process) and is further transferred onto a media sheet from the transfer belt (the second transfer process). The fixing unit then fixes the toner image on the media sheet.

Sound receiver 18 is a hardware device like a microphone so as to collect sounds (especially, operator's voice sounds), convert the sounds into electric signal to obtain sound information, and output the sound information to built-in controller 11 (sound analyzer 21 which will be described later).

Speaker 19 is a hardware device that outputs sound information, according to instructions given by built-in controller 11. For example, speaker 19 may give an operator of image forming apparatus 10 a message with sound, or output masking noise which is artificial sound that disturbs other persons' perception of operator's voice sounds (in other words, prevents operator's voice for operating image forming apparatus 10 from being perceived or heard by other people near the operator).

Image capturer 20 includes a hardware device for capturing images, like a CCD camera or a CMOS (complementary metal-oxide-semiconductor) camera so as to shoot an operator in a predetermined position with respect to image forming apparatus 10 (especially, shoot a mouse or lips of the operator). Image capturer 20 is configured to shoot an operator (for example, an operator facing image forming apparatus 10), obtain video information (video or static images taken at fixed intervals), and output the video information to built-in controller 11 (video analyzer 22 which will be described later).

As illustrated in FIG. 3B, built-in controller 11 is configured to work as sound analyzer 21, video analyzer 22, lip reader 23 and operation controller 24.

Sound analyzer 21 is configured to analyze sound information given by sound receiver 18 to recognize operator's utterances or contents of operator's speech (particularly an operation command to operate image forming apparatus 10) in the sound information, by using known technology. The way to recognize an operation command in sound information should not be limited to a particular way, and an arbitrary way may be used for the recognition. For example, sound analyzer 21 may use the way to judge whether a sound-to-word table includes detected voice sound, and if the table includes the voice sound, convert the voice sound to a corresponding command on the basis of the table, which is the way disclosed in JP-A No. 2013-153301.

Video analyzer 22 is configured to analyze video information given by image capturer 20 to detect movements of operator's lips (change of the shape of operator's lips) or an operator in the video information. Video analyzer 22 can make a judgment whether the movements of the lips come from utterances (speaking action of the operator), on the basis of, for example, whether the shape of operator's lips changes at predetermined time intervals.

Lip reader 23 is configured to interpret the movements of operator's lips (change of the shape of operator's lips) detected by video analyzer 22, to determine operator's utterances or contents of operator's speech, by using known lip-reading technology. The way to determine operator's utterances on the basis of a change of lips in shape should not be limited to a particular way, and an arbitrary way may be used for the determination. For example, lip reader 23 may use the way to determine operator's utterances by comparing lip movements detected in video information with lip movements corresponding to respective syllabics recorded as lip movement models in a lip-reading database, which is the way disclosed in JP-A No. 2015-220684.

Operation controller 24 is configured to, in response to recognition of an operation command to operate image forming apparatus 10 in the sound information with sound analyzer 21 during detection of movements of operator's lips in the video information with video analyzer 22, execute the operation command and control operations of image forming apparatus 10 according to the operation command. In a case that acceptance of an operation command is carries out by using information given by lip-reading, operation controller 24 is configured to judge whether an utterance determined by lip reader 23 matches an operation command recognized by sound analyzer 21, and control the operations of image forming apparatus 10 according to the judgment result. That is, if the determined utterance matches the recognized operation command, operation controller 24 executes the operation command so as to control operations of image forming apparatus 10 according to the operation command. If the determined utterance does not match the recognized operation command, operation controller 24 causes display and operation unit 14 to display information to prompt an operator to input an instruction by voice sound again. Further, when sound analyzer 21 failed to recognize an operation command to operate image forming apparatus 10 in the sound information, operation controller 24 executes one of the following processes. As one option, operation controller 24 controls operations of image forming apparatus 10 so as to reduce operation noise made by image forming apparatus 10 (noise reduction control). As another option, operation controller 24 causes display and operation unit 14 or speaker 19 to output information to prompt an operator to input, through display and operation unit 14 by hand, an instruction to operate the image forming apparatus 10. In the noise reduction control, operation controller 24 checks operations currently performed by image forming apparatus 10 and controls one or more operations, in which the image forming apparatus 10 makes relatively large operation noise (for example, operation noise being greater than a predetermined level of loudness), among the operations checked, so as to reduce the operation noise. The one or more operations to be controlled include, for example, one or more selected from: an operation to scan an original to obtain an original image with image scanner 15 (in which the ADF and/or the image scanner component of image scanner 15 can make operation noise); an operation to receive or send a document image with communication interface 13 (in which communication interface 13 can make operation noise); and an operation to form images on print medium with printing unit 17 (in which printing unit 17 can make operation noise). Operation controller 24 is further configured to, in response to display and operation unit 14 displaying a screen for inputting confidential information (like a password or a destination entail address), execute one or both of the following processes. As one option, operation controller 24 causes display and operation unit 14 or speaker 19 to output (display or sound) information to prompt an operator to input, by silent operator's lip movement, an instruction to operate image forming apparatus 10. As another option, operation controller 24 causes speaker 19 to output masking noise that disturbs other persons' perception of operator's voice sounds.

The sound analyzer 21, video analyzer 22, lip reader 23 and operation controller 24 may be constituted as hardware devices. Alternatively, the sound analyzer 21, video analyzer 22, lip reader 23 and operation controller 24 (particularly, sound analyzer 21, video analyzer 22 and operation controller 24) may be provided by the operation control program, which causes built-in controller 11 to function as these components when being executed by CPU 11a. That is, built-in controller 11 may be configured to serve as the sound analyzer 21, video analyzer 22, lip reader 23 and operation controller 24 (particularly, sound analyzer 21, video analyzer 22 and operation controller 24), when CPU 11a executes the operation control program.

It should be noted that FIG. 1, FIG. 2 and FIGS. 3A and 3B each illustrates an example of operation control system 10 according to die present embodiment for illustrative purpose only, and the constitution and operations of each apparatus in the system may be modified appropriately, as far as the above-described operations can be executed in the system.

For example, in the constitution illustrated in FIG. 3A, sound receiver 18 and image capturer 20 are installed in image forming apparatus 10, but alternatively, one or both of sound receiver 18 and image capturer 20 may be installed in one or more apparatuses in the system (for example, a remote terminal for controlling operating image forming apparatus 10), separately from image forming apparatus 10.

For another example, built-in controller 11 of image forming apparatus 10 of FIG. 3B includes sound analyzer 21, video analyzer 22 and lip reader 23, but alternatively, the system may include analysis server 30 that is communicably connected to image forming apparatus 10 and serves as at least one selected from sound analyzer 21, video analyzer 22 and lip reader 23, when a hardware processor of analysis server 30 executes the operation control program, instead of these components of the image forming apparatus 10.

### Operations of Image Forming Apparatus

Hereinafter, a description is given of operations of image forming apparatus 10 according to the present embodiment in details. CPU 11a of image forming apparatus 10 reads out the operation control program stored in ROM 11b or storage unit 12, loads the program onto RAM 11c, and executes the program, thereby executing the steps of the flowcharts illustrated in FIGS. 4 to 10.

### Basic Operations

As illustrated in FIG. 4, built-in controller 11 carries out command acceptance and operation control as follows. Built-in controller 11 (video analyzer 22) analyzes video information obtained by image capturer 20, to monitor movements of operator's lips (Step S101). In response to detection of movements of operator's lips in the video information with built-in controller 11 (video analyzer 22) (YES in Step S101), built-in controller 11 (sound analyzer 21) analyzes sound information obtained by sound receiver 18, to monitor input of an operation command to operate image forming apparatus 10 (Step S102). In response to recognition of an operation command to operate image forming apparatus 10 in the sound information with built-in controller 11 (sound analyzer 21) during the detection of the movements of operator's lips (YES in Step S102), built-in controller 11 (operation controller 24) accepts the operation command (Step S103), and executes the operation command and controls operations of image forming apparatus 10 according to the operation command.

### Operations Using Lip-Reading

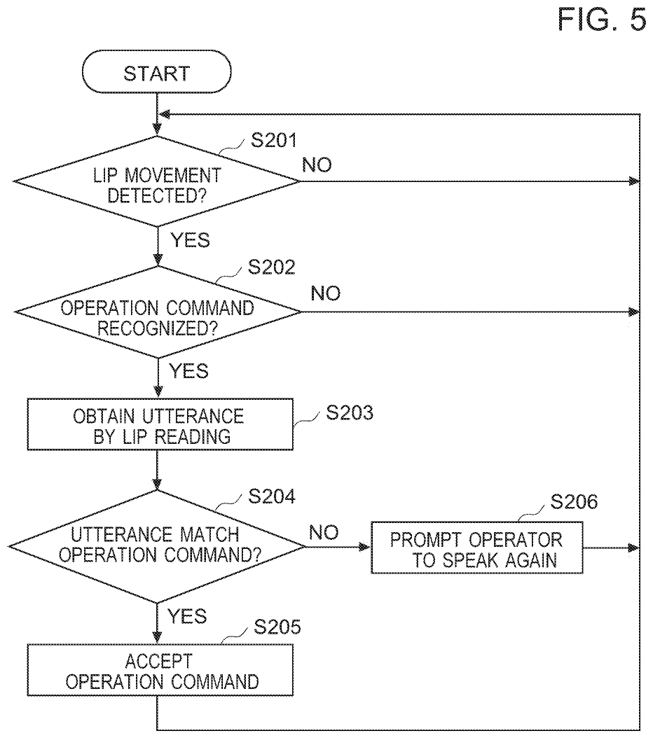

As illustrated in FIG. 5, built-in controller 11 may carry out command acceptance and operation control, using lip-reading. Built-in controller 11 (video analyzer 22) analyzes video information obtained by image capturer 20, to monitor movements of operator's lips (Step S201). In response to detection of movements of operator's lips in the video information with built-in controller 11 (video analyzer 22) (YES in Step S201), built-in controller 11 (sound analyzer 21) analyzes sound information obtained by sound receiver 18, to monitor input of an operation command to operate image forming apparatus 10 (Step S202). In response to recognition of an operation command to operate image forming apparatus 10 in the sound information with built-in controller 11 (sound analyzer 21) during the detection of the movements of operator's lips (YES in Step S202), built-in controller 11 (lip reader 23) interprets the movements of the operator's lips to determine an operator's utterance (the contents of operator's speech) and obtains the utterance (Step S203). Built-in controller 11 (operation controller 24) then judges whether the determined utterance matches the recognized operation command (Step S204). On judging that the utterance matches the operation command (YES in Step S204), built-in controller Ii (operation controller 24) accepts the operation command (Step S205), and executes the operation command and controls operations of image forming apparatus 10 according to the operation command. On judging that the utterance does not match the operation command (NO in Step S204), built-in controller 11 (operation controller 24) causes display and operation unit 14 to display information to prompt an operator to speak again (Step S206), because it indicates that speech recognition failure has occurred. For example, built-in controller 11 (operation controller 24) causes display and operation unit 14 to display notification screen 25 illustrated in FIG. 11 so as to prompt the operator to input an instruction by voice sound again.

Example of Operations with Difficulty in Speech Recognition

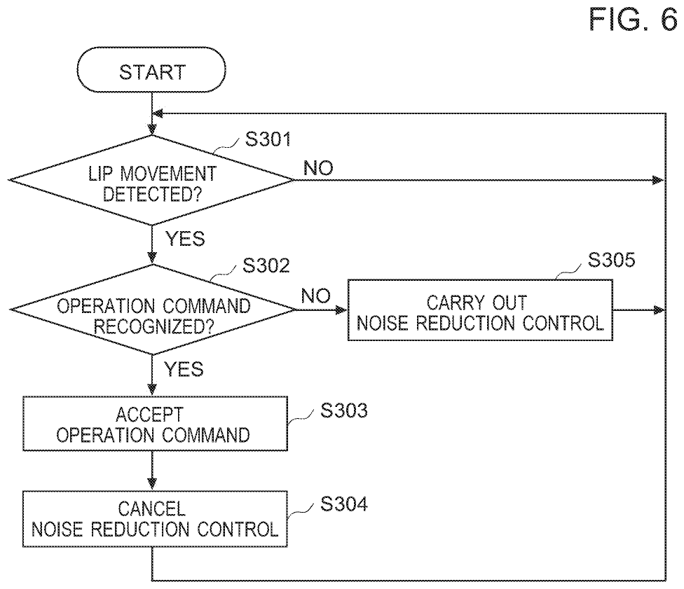

When there is difficulty in speech recognition, built-in controller 11 may carry out command acceptance and operation control, as illustrated in FIG. 6. Built-in controller 11 (video analyzer 22) analyzes video information obtained by image capturer 20, to monitor movements of operator's lips (Step S301). In response to detection of movements of operator's lips in the video information with built-in controller 11 (video analyzer 22) (YES in Step S301), built-in controller 11 (sound analyzer 21) analyzes sound information obtained by sound receiver 18, to monitor input of an operation command to operate image forming apparatus 10 (Step S302). When built-in controller 11 (sound analyzer 21) failed to recognize an operation command in the sound information (NO in Step S302), built-in controller 11 (operation controller 24) controls operations of image forming apparatus 10 so as to reduce operation noise made by image forming apparatus 10 (noise reduction control) (Step S305), because the operation noise may mask operator's voice sounds. In concrete terms, built-in controller 11 (operation controller 24) checks operations currently performed by image forming apparatus 10 and controls one or more operations, in which the image forming apparatus 10 makes operation noise being greater than a predetermined level of loudness, among the operations checked, so as to reduce the operation noise. Examples of the operations to be controlled includes operations to scan an original to obtain an original image with image scanner 15; operations to receive or send a document image with communication interface 13; and operations to form an image on print medium with printing unit 17. On the other hand, when built-in controller 11 (sound analyzer 21) recognized an operation command in the sound information in success (YES in Step S302), built-in controller 11 (operation controller 24) accepts the operation command (Step S303), and executes the operation command and controls operations of image forming apparatus 10 according to the operation command, and then cancels the noise reduction control if the noise reduction control is being carried out (Step S304).

Another Example of Operations with Difficulty in Speech Recognition

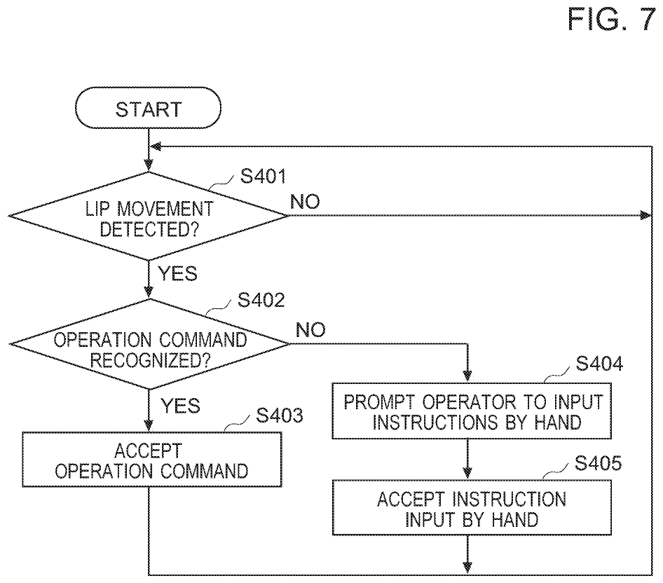

When there is difficulty in speech recognition, built-in controller 11 may carry out command acceptance and operation control, as illustrated in FIG. 7. Built-in controller 11 (video analyzer 22) analyzes video information obtained by image capturer 20, to monitor movements of operator's lips (Step S401). In response to detection of movements of operator's lips in the video information with built-in controller 11 (video analyzer 22) (YES in Step S401), built-in controller 11 (sound analyzer 21) analyzes sound information obtained by sound receiver 18, to monitor input of an operation command to operate image forming apparatus 10 (Step S402). When built-in controller 11 (sound analyzer 21) recognized an operation command in the sound information in success (YES in Step S402), built-in controller 11 (operation controller 24) accepts the operation command (Step S403), and executes the operation command and controls operations of image forming apparatus 10 according to the operation command. On the other hand, when built-in controller 11 (sound analyzer 21) failed to recognize an operation command in the sound information (NO in Step S402), built-in controller 11 (operation controller 24) causes display and operation unit 14 or speaker 19 to output information to prompt an operator to input, through display and operation unit 14 by hand, instructions to operate image forming apparatus 10 (Step S404), because surrounding noise may mask operator's voice sounds and accuracy of speech recognition may become low. For example, built-in controller 11 (operation controller 24) causes display and operation unit 14 to display notification screen 26 as illustrated in FIG. 12 and prompt an operator to input instructions to operate the apparatus by hand. After that, built-in controller 11 (operation controller 24) accepts an operator's instruction given by hand (Step S405), and executes the instruction and controls operations of image forming apparatus 10 according to the instruction.

Example of Operations when Confidential Information is Input

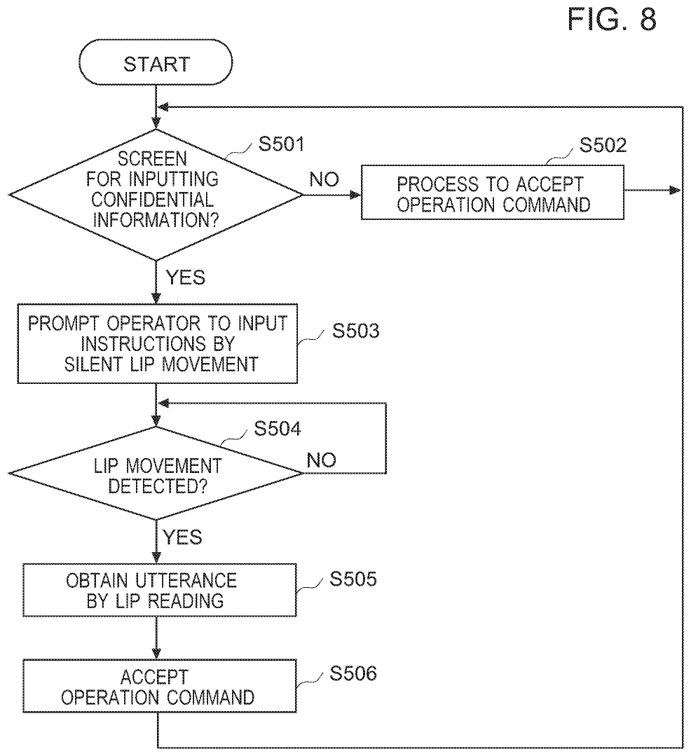

When confidential information is input, built-in controller 11 may carry out information acceptance and operation control, as illustrated in FIG. 8. Built-in controller 11 (operation controller 24) judges whether the screen displayed on display and operation unit 114 is a screen for inputting confidential information like a password or destination email address (Step S501). On judging that the screen is not such an input screen (NO in Step S501), built-in controller 11 carries out the command acceptance and operation control illustrated in FIG. 4, 5 or 6 (Step S502). On the other hand, on judging that the screen is a screen for inputting confidential information (YES in Step S501), built-in controller 11 (operation controller 24) causes display and operation unit 14 or speaker 19 to output (display or sound) information to prompt an operator to input, by silent operator's lip movements, instructions to operate image forming apparatus 10 (Step S503). For example, built-in controller 11 (operation controller 24) causes display and operation unit 14 to display notification screen 27 as illustrated in FIG. 13, and prompts an operator to input instructions to operate the apparatus by lip movements without sounds. After that, built-in controller 11 (video analyzer 22) analyzes video information obtained by image capturer 20, to monitor movements of operator's lips (Step S504). In response to detection of movements of operator's lips in the video information with built-in controller 11 (video analyzer 22) (YES in Step S504), built-in controller 11 (lip reader 23) interprets the movements of the operator's lips to determine an operator's utterance (the contents of operator's speech), and obtains the utterance (Step S505). Built-in controller 11 (operation controller 24) then accepts the utterance as an operation command (Step S506), and executes the operation command and controls operations of image forming apparatus 10 according to the operation command.

Another Example of Operations when Confidential Information is Input

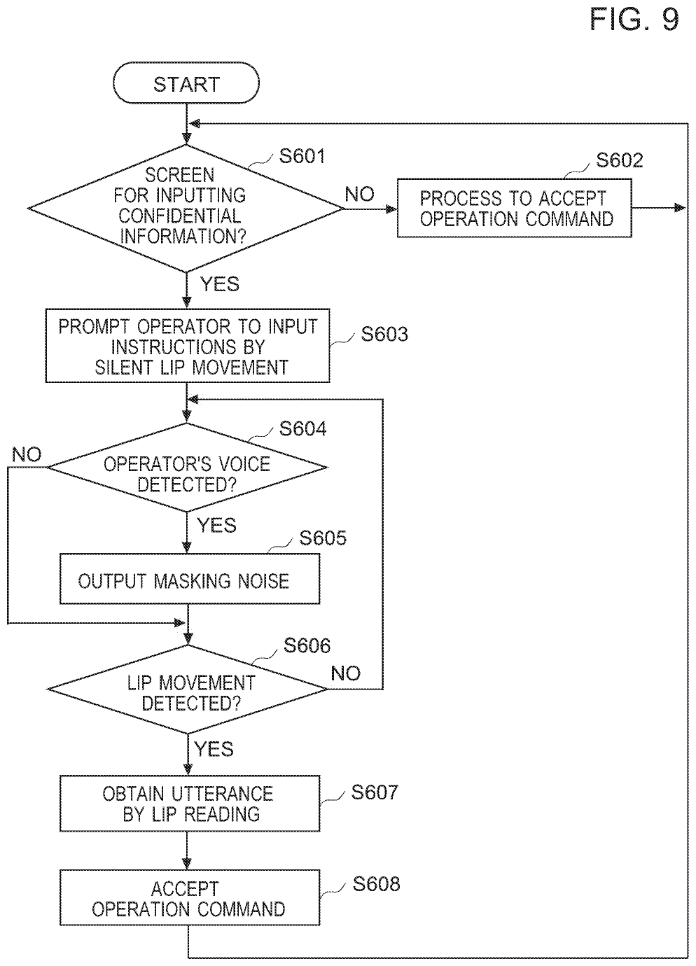

When confidential information is input, built-in controller 11 may carry out information acceptance and operation control, as illustrated in FIG. 9. Built-in controller 11 (operation controller 24) judges whether the screen displayed on display and operation unit 14 is a screen for inputting confidential information (Step S601). On judging that the screen is not such an input screen (NO in Step S601), built-in controller 11 carries out the command acceptance and operation control illustrated in FIG. 4, 5 or 6 (Step S602). On the other hand, on judging that the screen is a screen for inputting confidential information (YES in Step S601), built-in controller 11 (operation controller 24) causes display and operation unit 14 or speaker 19 to output (display or sound) information to prompt an operator to input, by silent operator's lip movements, instructions to operate image forming apparatus 10 (Step S603). After that, controller 11 (sound analyzer 21) analyzes sound information obtained by sound receiver IS, to monitor operator's voice sounds (Step S604). In response to detection of operator's voice sound in the sound information with built-in controller 11 (sound analyzer 21) (YES in Step S604), built-in controller 11 (operation controller 24) causes speaker 19 to output masking noise (Step S605) so as to avoid a leakage of confidential information. The masking noise may be arbitrary sound that can make other people's perception of operator's voice difficult, and examples of die masking noise include predetermined machine noises and sounds to cancel the voice sounds analyzed by built-in controller 11 (sound analyzer 21) (for example, a sound wave with the same amplitude but with inverted phase to the sounds to be cancelled), controller 11 (video analyzer 22) then analyzes video information obtained by image capturer 20, to monitor movements of operator's lips (Step S606). In response to detection of movements of operator's lips in the video information with built-in controller 11 (video analyzer 22) (YES in Step S606), built-in controller 11 (lip reader 23) interprets the movements of the operator's lips to determine an operator's utterance (the contents of operator's speech), and obtains the utterance (Step S607). Built-in controller 11 (operation controller 24) then accepts the utterance as an operation command (Step S608), and executes the operation command and controls operations of image forming apparatus 10 according to the operation command.

Another Example of Operations when Confidential Information is Input

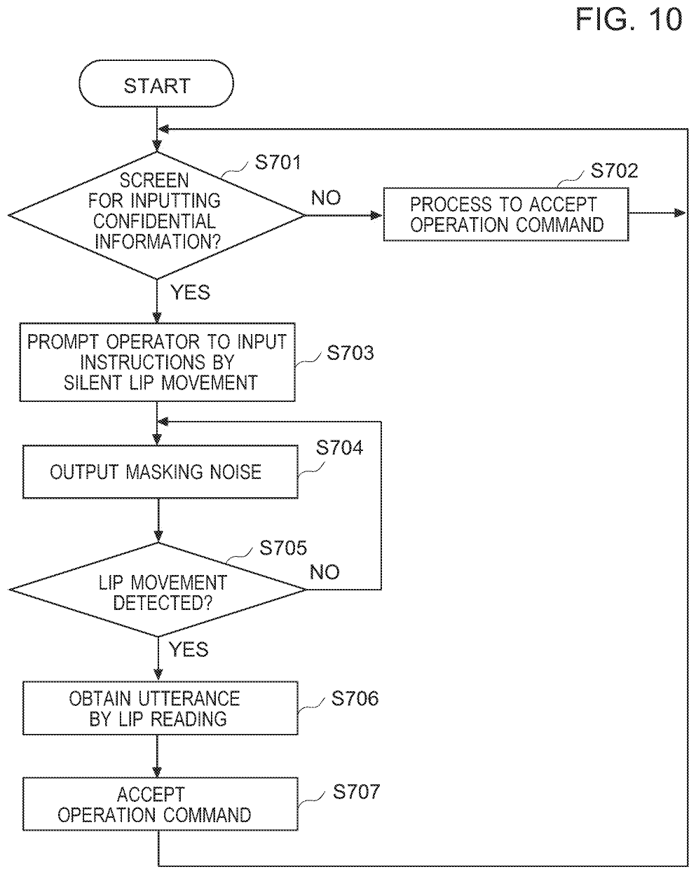

When confidential information is input, built-in controller 11 may carry out information acceptance and, operation control, as illustrated in FIG. 10. Built-in controller 11 (operation controller 24) judges whether the screen displayed on display and operation unit 14 is a screen for inputting confidential information (Step S701). On judging that the screen is not such an input screen (NO in Step S701), built-in controller 11 carries out the command acceptance and operation control illustrated in FIG. 4, 5 or 6 (Step S702). On the other hand, on judging that the screen is a screen for inputting confidential information (YES in Step S701), built-in controller 11 (operation controller 24) causes display and operation unit 14 or speaker 19 to output (display or sound) information to prompt an operator to input, by silent operator's lip movements, instructions to operate image forming apparatus 10 (Step S703), and then, causes speaker 19 to output masking noise (Step S704). After that, built-in controller 11 (video analyzer 22) then analyzes video information obtained by image capturer 20, to monitor movements of operator's lips (Step S705). In response to detection of movements of operator's lips in the video information with built-in controller 11 (video analyzer 22) (YES in Step S705), built-in controller 11 (lip reader 23) interprets the movements of the operator's lips to determine an operator's utterance (the contents of operator's speech), and obtains the utterance (Step S706). Built-in controller 11 (operation controller 24) then accepts the utterance as an operation command (Step S707), and executes the operation command and controls operations of image forming apparatus 10 according to the operation command.

As described above, built-in controller 11 of image forming apparatus 10 is configured to not only analyze sound information, but also analyze video information to detect movements of operator's lips in the video information and, as needed, interpret the movements of the operator's lips to determine an operator's utterance (the contents of operator's speech). It prevents erroneous speech recognition that comes from surrounding noise made during voice input and allows execution of voice commands to operate image forming apparatus 10 accurately.

### Second Embodiment

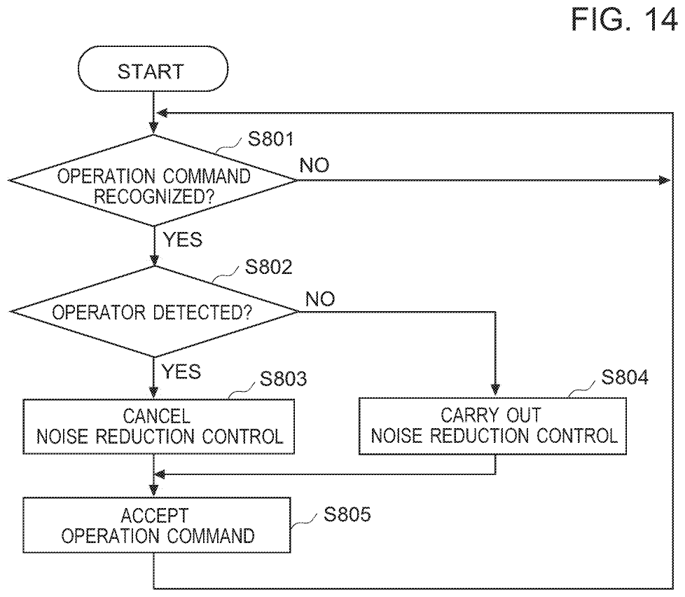

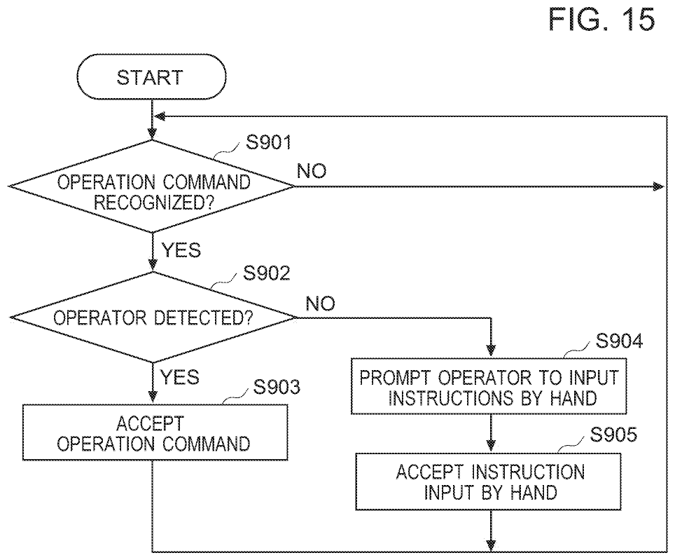

Next, a description is given of an image processing apparatus, a method for controlling operations of the image processing apparatus, and a non-transitory computer-readable recording medium storing a program for controlling operations of the image processing apparatus, according to the second embodiment, with reference to FIG. 14 and FIG. 15. FIG. 14 and FIG. 15 each is a flowchart of an example of operations of the image forming apparatus, which is an instance of an image processing apparatus according to the present embodiment.

The above-described first embodiment gave a description of the control of operations of image forming apparatus 10 according to an operation command that is recognized by sound analyzer 21 during detection of operator's lip movements with video analyzer 22. If an operator is out of the shooting area of image capturer 20, video analyzer 22 cannot detect the operator and the operator may fail to operate image forming apparatus 10 with voice commands. In view of that, the present embodiment employs operations of image forming apparatus 10, that allow an operator even who is out of the shooting area of image capturer 20 to operate image forming apparatus 10 appropriately.

To achieve such operations, there is provided image forming apparatus 10 having the construction being the same as that of the first embodiment, but built-in controller 11 (operation controller 24) is configured to perform the following operations. That is, in response to recognition of an operation command in sound information with built-in controller 11 (sound analyzer 21), built-in controller 11 (operation controller 24) judges whether an operator is detected in video information given by image capturer 20, with video analyzer 22. If no operator is detected in the video information with video analyzer 22, built-in controller 11 (operation controller 24) carries out the noise reduction control so as to reduce operation noise made by image forming apparatus 10; or causes display and operation unit 14 or speaker 19 to output information to prompt an operator to input, through display and operation unit 14 by hand, instructions to operate image forming apparatus 10. In the noise reduction control, built-in controller 11 (operation controller 24) checks operations currently performed by image forming apparatus 10 and controls one or more operations, in which the image forming apparatus 10 makes operation noise being greater than a predetermined level of loudness, among the operations checked, so as to reduce the operation noise.

Hereinafter, a description is given of operations of image forming apparatus 10 according to the present embodiment in details. CPU 11a of image forming apparatus 10 reads out the operation control program stored in ROM 11b or storage unit 12, loads the program onto RAM 11c, and executes the program, thereby executing the steps of the flowcharts illustrated in FIGS. 14 and 15.

Example of Operations with Difficulty in Speech Recognition

When there is difficulty in speech recognition, built-in controller 11 may early out command acceptance and operation control, as illustrated in FIG. 14. Built-in controller 11 (sound analyzer 21) analyzes sound information obtained by sound receiver 18, to monitor input of an operation command (Step S801). In response to recognition of an operation command in the sound information with built-in controller 11 (sound analyzer 21) (YES in Step S801), built-in controller 11 (video analyzer 22) analyzes video information obtained by image capturer 20 and judges whether an operator is detected in the video information (Step S802). On judging that built-in controller 11 (video analyzer 22) has detected no operator in the video information (NO in Step S802), it indicates that an operator who is out of the shooting area of image capturer 20 (for example, an operator at the side of the image forming apparatus 10) speaks, and operation noise made by image forming apparatus 10 may affect the recognition of an operation command with sound analyzer 21. Therefore, built-in controller 11 (operation controller 24) controls operations of image forming apparatus 10 so as to reduce operation noise made by image forming apparatus 10 (noise reduction control) (Step S804). In concrete terms, built-in controller 11 (operation controller 24) checks operations currently performed by image forming apparatus 10 and controls one or more operations, in which the image forming apparatus 10 makes operation noise being greater than a predetermined level of loudness, among the operations checked, so as to reduce the operation noise. Examples of the operations to be controlled includes operations to scan an original to obtain an original image with image scanner 15; operations to receive or send a document image with communication interface 13; and operations to form an image on print medium with printing unit 17. On the other hand, on judging that built-in controller 11 (video analyzer 22) has detected an operator in the video information (YES in Step S802), it indicates that an operator who is within the shooting area of image capturer 20 (for example, an operator at the front of or facing the image forming apparatus 10) speaks, and it can be considered that the recognition of an operation command with sound analyzer 21 is less affected by operation noise made by image forming apparatus 10. Therefore, built-in controller 11 (operation controller 24) cancels the noise reduction control if the noise reduction control is being carried out (Step S803). After that, built-in controller 11 (operation controller 24) accepts the operation command (Step S805), and executes the operation command and controls operations of image forming apparatus 10 according to the operation command.

Another Example of Operations with Difficulty in Speech Recognition

When there is difficulty in speech recognition, built-in controller 11 may carry out command acceptance and operation control, as illustrated in FIG. 15. Built-in controller 11 (video analyzer 22) analyzes sound information obtained by sound receiver 18, to monitor input of an operation command (Step S901). In response to recognition of an operation command in the sound information with built-in controller 11 (sound analyzer 21) (YES in Step S901), built-in controller 11 (video analyzer 22) analyzes video information obtained by image capturer 20 and judges whether an operator is detected in the video information (Step S902). On judging that built-in controller 11 (video analyzer 22) has detected an operator in the video information (YES in Step S902), built-in controller 11 (operation controller 24) accepts the operation command (Step S903), and executes the operation command and controls operations of image forming apparatus 10 according to the operation command. On the other hand, on judging that built-in controller 11 (video analyzer 22) has detected no operator in the video information (NO in Step S902), it indicates that an operator who is out of the shooting area of image capturer 20 (for example, an operator at the side of the image forming apparatus 10) speaks, and operation noise made by image forming apparatus 10 may affect the recognition of an operation command with sound analyzer 21. Therefore, built-in controller 11 (operation controller 24) causes display and operation unit 14 or speaker 19 to output information to prompt the operator to input, through display and operation unit 14 by hand, instructions to operate image forming apparatus 10 (Step S904). For example, built-in controller 11 (operation controller 24) causes display and operation unit 14 to display notification screen 26 as illustrated in FIG. 12 and prompt the operator to input instructions to operate the apparatus by hand. After that, built-in controller 11 (operation controller 24) accepts an operator's instruction given by hand (Step S905), and executes the instruction and controls operations of image forming apparatus 10 according to the instruction.

As described above, built-in controller 11 of image forming apparatus 10 is configured to not only analyze sound information, but also analyze video information to detect an operator facing the apparatus. It prevents erroneous speech recognition that comes from surrounding noise made during voice input, and allows an operator to operate the apparatus accurately.

It should be noted that the present invention should not be limited to the above-described embodiments, and the constitution and operations of the image processing apparatus and the system including the image processing apparatus can be modified appropriately, unless the modification deviates from the intention of the present invention.

For example, the above-described embodiments gave descriptions of the control of operations of image forming apparatus 10 (in other words, an image processing apparatus equipped with a print engine), but it should be noted that applications of the present invention should not be limited to image forming apparatuses. The disclosed operation control method is similarly applicable to operations of arbitrary kinds of image processing apparatus, such as scanners (image processing apparatuses equipped with an image scanner), facsimile machines (image processing apparatuses equipped with a communication interface for facsimile communication) and printing machines (image processing apparatuses equipped with a print engine), each of which can make operation noise.

The present invention is applicable to image processing apparatuses that provide voice command capabilities; operation control methods and operation control programs that allow an operator to operate the image processing apparatus with voice commands and non-transitory computer-readable recording media each storing the program.

Although embodiments of the present invention have been described and illustrated in detail, it is clearly understood that the same is by way of illustration and example only and not limitation, the scope of the present invention should be interpreted by terms of the appended claims.

1. An image processing apparatus comprising:
an user interface comprising
a display that presents information to an operator and
an input hardware device that receives an instruction given by the operator;
a sound receiver that obtains operator's voice sounds and outputs sound information;
an image capturer that shoots the operator and outputs video information; and
a hardware processor that is communicably connected to the user interface, the sound receiver and the image capturer and that performs operations comprising:
first analyzing the sound information to recognize an operation command to operate the image processing apparatus in the sound information;
second analyzing the video information to detect movements of operator's lips in the video information; and
in response to recognizing an operation command to operate the image processing apparatus in the first analyzing during detection of the movements of operator's lips in the second analyzing, executing the operation command.

2. The image processing apparatus of claim 1,
wherein the operations further comprise determining an operator's utterance by interpreting the movements of operator's lips, and
the executing comprises
judging whether the utterance matches the operation command recognized in the first analyzing, and
on judging that the utterance matches the operation command, executing the operation command.

3. The image processing apparatus of claim 2,
wherein the executing comprises, on judging that the utterance does not match the operation command, causing the display of the user interface to display information to prompt the operator to input an instruction by voice sound again.

4. The image processing apparatus of claim 1,
wherein the executing further comprises, on failing to recognize an operation command to operate the image processing apparatus in the first analyzing, checking operations currently performed by the image processing apparatus and controlling one or more operations, in which the image processing apparatus makes operation noise being greater than a predetermined level of loudness, among the operations checked, so as to reduce the operation noise.

5. The image processing apparatus of claim 4,
wherein the image processing apparatus further comprises one or more selected from an image scanner, a communication interface for facsimile communication and a print engine, and
the one or more operations, in which the image processing apparatus makes operation noise being greater than the predetermined level of loudness, include one or more selected from
an operation to scan an original to obtain an original image with the image scanner,
an operation to receive or send a document image with the communication interface, and
an operation to form an image on mint medium with the print engine.

6. The image processing apparatus of claim 1, further comprising a speaker that outputs sound information to the operator,
wherein the executing further comprises, on failing to recognize an operation command to operate the image processing apparatus in the first analyzing, causing the display of the user interface or the speaker to output information to prompt the operator to input, through the input hardware device of the user interface by hand, an instruction to operate the image processing apparatus.

7. The image processing apparatus of claim 1, further comprising a speaker that outputs sound information to the operator,
wherein the executing further comprises, in response to the display of the user interface displaying, a screen for inputting confidential information, causing the display of the user interface or the speaker to output information to prompt the operator to input, by a silent operator's lip movement, an instruction to operate the image processing apparatus.

8. The image processing apparatus of claim 7,
wherein the executing further comprises, in response to the display of the user interface displaying the screen for inputting confidential information, causing the speaker to output masking noise that disturbs other persons' perception of operator's voice sounds.

9. The image processing apparatus of claim 8,
wherein in the executing, the hardware processor causes the speaker to output the masking noise, on detecting operator's voice sound in the sound information in the first analyzing.

10. An image processing apparatus comprising:
an user interface comprising
a display that presents information to an operator and
an input hardware device that receives an instruction given by the operator;
a sound receiver that obtains operator's voice sounds and outputs sound information;
an image captures that shoots the operator and outputs video information;
a speaker that outputs sound information to the operator; and
a hardware processor that is communicably connected to the user interface, the sound receiver, the image capturer and the speaker and that performs operations comprising:
first analyzing the sound information to recognize an operation command to operate the image processing apparatus in the sound information;
second analyzing the video information to detect the operator in the video information;
in response to recognizing an operation command to operate the image processing apparatus in the first analyzing, judging whether the operator is detected in the video information; and
on judging that no operator is detected in the video information, carrying out either of
checking operations currently performed by the image processing apparatus and controlling one or more operations, in which the image processing apparatus makes operation noise being greater than a predetermined level of loudness, among the operations checked, so as to reduce the operation noise, or
causing the display of the user interface or the speaker to output information to prompt the operator to input, through the input hardware device of the user interface by hand, an instruction to operate the image processing apparatus.

11. The image processing apparatus of claim 10,
wherein the image processing apparatus further comprises one or more selected from an image seamier, a communication interface for facsimile communication and a print engine, and
the one or more operations, in which the image processing apparatus makes operation noise being greater than the predetermined level of loudness, include one or more selected from
an operation to scan an original to obtain an original image with the image scanner,
an operation to receive or send a document image with the communication interface, and
an operation to form an image on print medium with the print engine.

12. A method for controlling operations of an image processing apparatus equipped with: an user interface that presents information to an operator with a display and receives an instruction given by the operator with an input hardware device; a sound receiver that obtains operator's voice sounds and outputs sound information; and an image capturer that shoots the operator and outputs video information,
the method comprising:
first analyzing, by one or more hardware processors that control the image processing apparatus, the sound information to recognize an operation command to operate the image processing apparatus in the sound information;
second analyzing, by one or more hardware processors that control the image processing apparatus, the video information to detect movements of operator's lips in the video information; and
in response to recognizing an operation command to operate the image processing apparatus in the first analyzing during detection of the movements of operator's lips in the second analyzing, executing, by one or more hardware processors that control the image processing apparatus, the operation command.

13. The method of claim 12, further comprising determining, by one or more hardware processors that control the image processing apparatus, an operator's utterance by interpreting the movements of operator's lips,
wherein the executing comprises
judging whether the utterance matches the operation command recognized in the first analyzing, and
on judging that the utterance matches the operation command, executing the operation command.

14. The method of claim 13,
wherein the executing comprises, on judging that the utterance does not match the operation command, causing the display of the user interface to display information to prompt the operator to input an instruction by voice sound again.

15. The method of claim 12,
wherein the executing further comprises, on failing to recognize an operation command to operate the image processing apparatus in the first analyzing, checking operations currently performed by the image processing apparatus and controlling one or more operations, in which the image processing apparatus makes operation noise being greater than a predetermined level of loudness, among the operations checked, so as to reduce the operation noise.

16. The method of claim 15,
wherein the image processing apparatus comprises one or more selected from an image scanner, a communication interface for facsimile communication and a print engine, and
the one or more operations, in which the image processing apparatus makes operation noise being greater than the predetermined level of loudness, include one or more selected from
an operation to scan an original to obtain an original image with the image scanner,
an operation to receive or send a document image with the communication interface, and
an operation to form an image on print medium with the print engine.

17. The method of claim 12,
wherein the executing further comprises, on failing to recognize an operation command to operate the image processing apparatus in the first analyzing, causing the display of the user interface or a speaker of the image processing apparatus to output information to prompt the operator to input, through the input hardware device of the user interface by hand, an instruction to operate the image processing apparatus.

18. The method of claim 12,
wherein the executing further comprises, in response to the display of the user interface displaying a screen for inputting confidential information, causing the display of the user interface or a speaker of the image processing apparatus to output information to prompt the operator to input, by a silent operator's lip movement, an instruction to operate the image processing apparatus.

19. The method of claim 18,
wherein the executing further comprises, in response to the display of the user interface displaying the screen for inputting confidential information, causing the speaker to output masking noise that disturbs other persons' perception of operator's voice sounds.

20. The method of claim 19,
wherein in the executing, the one or more hardware processors cause the speaker to output the masking noise, on detecting operator's voice sound in the sound information in the first analyzing.

21. The method of claim 12,
wherein the image processing apparatus is communicably connected to an analysis server through a communication network, and
one or both of the first analyzing and the second analyzing are performed by a hardware processor of the analysis server.

22. A method for controlling operations of an image processing apparatus equipped with: an user interface that presents information to an operator with a display and receives an instruction given by the operator with an input hardware device; a sound receiver that obtains operator's voice sounds and outputs sound information; and an image capturer that shoots the operator and outputs video information,
the method comprising:
first analyzing, by one or more hardware processors that control the image processing apparatus, the sound information to recognize an operation command to operate the image processing apparatus in the sound information;
second analyzing, by one or more hardware processors that control the image processing apparatus, the video information to detect the operator in the video information;
in response to recognizing an operation command to operate the image processing apparatus in the first analyzing, judging, by one or more hardware processors that control the image processing apparatus, whether the operator is detected in the video information; and
on judging that no operator is detected in the video information, carrying out, by one or more hardware processors that control the image processing apparatus, either of
checking operations currently performed by the image processing apparatus and controlling one or more operations, in which the image processing apparatus makes operation noise being greater than a predetermined level of loudness, among the operations checked, so as to reduce the operation noise, or
causing the display of the user interface or a speaker of the image processing apparatus to output information to prompt the operator to input, through the user interface by hand, an instruction to operate the image processing apparatus.

23. The method of claim 22,
wherein the image processing apparatus comprises one or more selected from an image scanner, a communication interface for facsimile communication and a print engine, and
the one or more operations, in which the image processing apparatus names operation noise being greater than the predetermined level of loudness, include one or more selected from
an operation to scan an original to obtain an original image with the image scanner,
an operation to receive or send a document image with the communication interface, and
an operation to form an image on print medium with the print engine.

24. The method of claim 22,
wherein the image processing apparatus is communicably connected to an analysis server through a communication network, and
one or both of the first analyzing and the second analyzing are performed by a hardware processor of the analysis server.

25. A non-transitory computer-readable recording medium storing a program for controlling operations of an image processing apparatus equipped with: an user interface that presents information to an operator with a display and receives an instruction given by the operator with an input hardware device; a sound receiver that obtains operator's voice sounds and outputs sound information; and an image capturer that shoots the operator and outputs video information,
the program comprising instructions which, when being executed by a hardware processor of the image processing apparatus, cause the hardware processor to perform operations comprising:
first analyzing the sound information to recognize an operation command to operate the image processing apparatus in the sound information;
second analyzing the video information to detect movements of operator's lips in the video information; and
in response to recognizing an operation command to operate the image processing apparatus in the first analyzing during detection of the movements of operator's lips in the second analyzing, executing the operation command.

26. A non-transitory computer-readable recording medium storing a program for controlling operations of image processing apparatus equipped with: an user interface that presents information to an operator with a display and receives an instruction given by the operator with an input hardware device: a sound receiver that obtains operator's voice sounds and outputs sound information; and an image capturer that shoots the operator and outputs video information,
the program comprising instructions which, when being executed by a hardware processor of the image processing apparatus, cause the hardware processor to perform operations comprising:
first analyzing the sound information to recognize an operation command to operate the image processing apparatus in the sound information;
second analyzing the video information to detect the operator in the video information;
in response to recognizing an operation command to operate the image processing apparatus in the first analyzing, judging whether the operator is detected in the video information; and
on judging that no operator is detected in the video information, carrying out either of
checking operations currently performed by the image processing apparatus and controlling one or more operations, in which the image processing apparatus makes operation noise being greater than a predetermined level of loudness, among the operations checked, so as to reduce the operation noise, or
causing the display of the user interface or a speaker of the image processing apparatus to output information to prompt the operator to input, through the user interface by hand, an instruction to operate the image processing apparatus.
